(19) United States
(12) Patent Application Publication
(10) Pub. No.: US 2025/0284329 A1
(43) Pub. Date: Sep. 11, 2025

(54) POINT OF SALE DEVICE WITH CAPACITOR FOR BACKUP POWER

(71) Applicant: Fiserv, Inc., Milwaukee, WI (US)

(72) Inventors: Victor Pan, Fremont, CA (US); Narayanan Gopalakrishnan, Newark, CA (US); Yi Sun, San Jose, CA (US)

(73) Assignee: Fiserv, Inc., Milwaukee, WI (US)

(21) Appl. No.: 19/073,328

(22) Filed: Mar. 7, 2025

Related U.S. Application Data
(60) Provisional application No. 63/563,241, filed on Mar. 8, 2024.

(51) Int. Cl. G06F 1/30; G07G 3/00

(52) U.S. Cl. CPC G06F 1/30; G07G 3/00

(57) ABSTRACT

A point-of-sale (POS) device may include an input device to receive transaction data, a processor to process the transaction data, a storage memory to store the transaction data, a supercapacitor to provide power to the processor in response to a loss in power, and a voltage monitor to monitor an input voltage to the POS device to identify the loss in power and provide an alert to the processor indicating the loss in power, wherein, in response to the alert, the processor stores the transaction data in the storage memory.

### CROSS-REFERENCE TO RELATED APPLICATIONS

This application claims priority to U.S. Provisional Application No. 63/563,241, filed Mar. 8, 2024, which application is incorporated herein by reference.

### BACKGROUND

Point of sale devices handle transaction data which may be lost due to a power failure. Some point of sale devices include batteries for backup power, but as batteries age, they may lose the ability to hold a charge and/or swell.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

Aspects of the present disclosure are directed to a point-of-sale (POS) device, including an input device to receive transaction data, a processor to process the transaction data, a storage memory to store the transaction data, a supercapacitor to provide power to the processor in response to a loss in power, and a voltage monitor to monitor an input voltage to the POS device to identify the loss in power and provide an alert to the processor indicating the loss in power, wherein, in response to the alert, the processor stores the transaction data in the storage memory.

In some implementations, the POS device includes a volatile memory, wherein the processor stores the transaction data from the volatile memory to the storage memory. In some implementations, the transaction data includes transaction data which was being written to the storage memory when the loss in power was identified. In some implementations, the transaction data includes cached transaction data in the volatile memory. In some implementations, the processor, in response to the alert indicating the loss in power, shuts down subsystems of the POS device to conserve the power provided by the supercapacitor. In some implementations, the POS device includes a display, wherein shutting down the subsystems of the POS device includes shutting down the display. In some implementations, shutting down the subsystems of the POS device includes shutting down the subsystems of the POS device directly from a kernel of an operating system running on the processor. In some implementations, the processor, in response to the transaction data being stored in the storage memory during the loss in power, shuts down the POS device. In some implementations, the voltage monitor identifies the loss in power by determining that the input voltage has dropped below a predetermined threshold. In some implementations, the processor stores the transaction data in the storage memory within 500 ms of the voltage monitor identifying the loss in power.

Aspects of the present disclosure are directed to a method, including identifying a loss in input power to a point-of-sale (POS) device, in response to the loss in input power to the POS device, providing power to a processor of the POS device using a supercapacitor, in response to the loss in input power to the POS device, writing, using the processor of the POS device, transaction data from a volatile memory of the POS device to a non-volatile memory of the POS device, and in response to the transaction data being written to the non-volatile memory, automatically shutting down, using the processor, the POS device.

In some implementations, identifying the loss in input power includes monitoring an input voltage to the POS device. In some implementations, identifying the loss in input power includes determining that the input voltage has dropped below a predetermined threshold. In some implementations, the transaction data includes transaction data which was being written to the non-volatile memory when the loss in power was identified. In some implementations, the transaction data includes cached transaction data in the volatile memory. In some implementations, in response to the loss in input power to the POS device, shutting down, by the processor, subsystems of the POS device to conserve the power provided by the supercapacitor. In some implementations, shutting down the subsystems of the POS device includes shutting down a display of the POS device. In some implementations, shutting down, by the processor, the subsystems of the POS device includes shutting down the subsystems of the POS device directly from a kernel of an operating system running on the processor. In some implementations, the method includes making, by the processor, a power off API call to the one or more subsystems of the POS device. In some implementations, the processor stores the transaction data to the non-volatile memory within 500 ms of the identification of the loss in power.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 is an example block diagram of a secure point-of-sale (POS) platform.

FIG. 2 is an example block diagram of components of a POS device including a rechargeable battery.

FIG. 3 is an example block diagram of components of a POS device including a supercapacitor.

FIG. 4 is an example block diagram illustrating a system for implementing a graceful shutdown for a POS device.

FIG. 5 is an example flow chart of a method for implementing a graceful shutdown for a POS device.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

After a payment transaction is performed at a point-of-sale (POS) device the POS device needs to write transaction data of the payment transaction to a storage memory (i.e., non-volatile memory) of the POS device. In the event of a loss of power to the POS device, the transaction data may be corrupted and/or lost. Power loss may result in loss or corruption of the transaction data, as the POS device could be writing data to the storage memory at the time of the power loss, leading to incomplete write actions and potentially causing data loss or data corruption. This problem is especially severe when POS devices store offline transactions in the POS device without syncing with a payment gateway. When data loss occurs, the offline transactions may be lost, preventing the POS device from submitting the offline transactions to a payment network and leading to a loss of funds for a merchant.

Some conventional POS devices include a rechargeable battery (e.g., lithium-ion battery) to provide backup power to enable them to complete operations they were performing at the time of the unexpected power loss. However, integrating a lithium-ion battery in a POS device is costly and presents reliability issues over time. The lithium-ion battery requires a battery charger circuit to charge the battery, a gas gauge circuit to track a capacity of the battery, and various safety circuits to keep the device operating safely during charging and discharging.

The present disclosure provides the advantage of a graceful shutdown of a POS device without use of a battery, and accompanying charger and gas gauge circuits, by providing backup power to the POS device using a supercapacitor of the POS device. The supercapacitor can automatically and immediately provide power to the POS device in response to a loss in power to the POS device. A processor of the POS device can automatically shut down subsystems of the POS device in response to the loss in power to conserve the power provided by the supercapacitor. The processor can shut down the subsystems of the POS device from kernel space to rapidly shut down the subsystems. In this way, the POS device can execute a rapid and graceful shutdown without loss or corruption of transaction data in response to a loss in power.

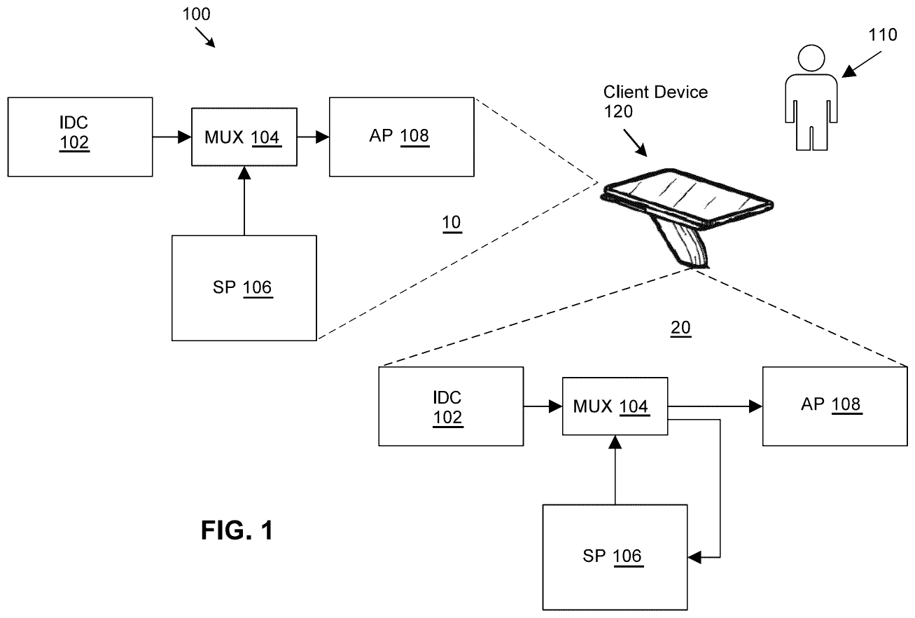

As shown in FIG. 1, secure POS platform 100 may include a number of hardware components including input device controller (IDC) 102, multiplexer (MUX) 104, secure processor (SP) 106, and applications processor (AP) 108. Throughout this specification, a touch screen will be used as an exemplary input device such that the input device controller may be referred to as a touch controller (TC). However, as mentioned previously, the input device controller could be a controller for any number of input devices or user interfaces such as a keypad, audio interface, or wireless interface. The above are only examples of components that may be included in a secure POS platform, such as 100, and other components may also be included.

Referring to FIG. 1, there is shown an example schematic view of a secure POS platform 100 in accordance with one or more example embodiments. In FIG. 1, secure POS platform 100 can include one or more components, such as 102, 104, 106, and 108 that are internal to associated client device 120, which can be a merchant POS device. Client device 120 may be operated by a user 110 entering various information for a purchase transaction via an associated input device associated with the client device 120 to facilitate a purchase transaction. The input device could be a touch screen integrated with the client device 120. The input device could be a multiuse input device such that it is used for both secure operations and normal (non-secure) operations. Secure POS platform 100 may evaluate whether the certain user inputs via the multiuse input device are associated with either secure operations or normal (non-secure) operations. An example of a secure operation is entering a PIN. An example of a non-secure operation is entering a quantity of an item to be purchased via the same touch screen.

The hardware components, such as 102, 104, and 106, may be interconnected to provide various functions in response to certain actions performed by user 110 with respect to client device 120, such as inputting information via an associated input device or user interface. The hardware components can be implemented as individual integrated circuits (ICs) on a main board of client device 120. However, MUX 104 and SP 106 could also be implemented on a single application specific integrated circuit (ASIC) while IDC 102 and AP 108 are kept as separate ICs. The chip comprising MUX 104 and SP 106 could then be used as a “secure chip” in a chip set comprising the secure chip, IDC 102, and AP 108. As will be described later, integrating MUX 104 and SP 106 onto a single chip provides certain benefits in that IDC 102 and AP 108 could be commercially available ICs that are broadly available beyond the more limited market for specialized secure POS hardware. In other words, an application processor chip and peripheral controller chip could be standard devices for the control of peripherals and running applications generally, and do not need to be augmented in any manner to realize the security benefits of some of the approaches described herein. Any of the functions performed by SP 106 that are disclosed in this specification could be executed on the secure chip. For example, tamper detection circuitry implemented on the secure chip could receive a tamper indication from a tamper sensor and clear a memory implemented on the secure chip to protect encryption keys or other secure information stored on the secure chip.

AP 108 can be a standard processor used to implement an operating system for client device 120. For example, AP 108 can run the Android OS™. In general, the AP can maintain full control over the client device 120 while the device is running applications that don't require secure information. For example, the main application run by the AP 108 could be the standard merchant-facing retail checkout application used to accept inputs regarding a customer's order and tally the total of a specific purchase transaction. As another example, the main application run by AP 108 could be a restaurant server's ordering application used to input orders taken by the server. AP 108 can operate with a cache and main memory that are physically separate from the memory used by SP 106. This configuration provides certain benefits in that certain attacks may use a processor to write instructions to memory for later execution and exploitation of a secure program running on the same processor, or may use the processor to read and illicitly obtain data from the memory which was utilized and left over by a secure program using the same memory. These kinds of vulnerabilities can be avoided by not allowing the AP to have access to the same memory as the SP. MUX 104 is a hardware multiplexer that receives control inputs from SP 106 and routes data received from IDC 102 to one or more data channels based on those control inputs. The data could be routed through transistors that turn on or off in response to control signals. MUX 104 could be an IC with one or more control pins, one or more input pins and at least two output pins. In approaches where MUX 104 and SP 106 were implemented on a single chip, MUX 104 could be a block of analog circuitry on the secure chip controlled by a digital output from SP 106. In such approaches, MUX 104 and SP 106 could exchange information via interconnects in the IC.

In some embodiments, illustrated by the region of FIG. 1 indicated by reference number 10, a secure transaction process can be implemented using the hardware components shown in the portion of FIG. 1 indicated by reference number 10. For example, when user 110 interacts with an input device or user interface associated with client device 120, IDC 102 can transmit certain user inputs to MUX 104. In certain instances, when secure POS platform 100 detects or prompts user entry of secure data (e.g., a user entering PIN information) via the input device or user interface associated with client device 120, the operation is treated as a secure transaction and/or operation. In this instance, SP 106 can control the flow of secure data through MUX 104.

FIG. 1 illustrates another example schematic view of a secure POS platform which is illustrated by the region of FIG. 1 indicated by reference number 20, which is in accordance with one or more example embodiments. In the embodiments indicated by reference number 20, entry of data that may be considered non-secure (normal mode) can be facilitated via the hardware components, such as 102, 104, 106, and 108 of client device 120, such that data passes from a peripheral to AP 108. For example, IDC 102 may communicate user inputs to MUX 104, such as when user 110 interacts with an associated input device or user interface. MUX 104 can then pass the information received from this interaction to AP 108. AP 108 may then perform transactions and/or operations that may be considered non-secure. In addition, entry of data that may be considered secure can be facilitated via the same hardware components, such as 102, 104, 106, and 108 of client device 120. However, the data from the peripheral will now be routed to SP 106 instead of AP 108. For example, under the control of SP 106, MUX 104 will route input data from the peripheral to SP 106. SP 106 may then perform operations on the data that may be considered secure. IDC 102 may be completely unaware as to which processor the input data is being routed to.

The secure POS platform 100 may be a secure POS platform as described in U.S. Pat. No. 11,393,300, which patent is incorporated herein by reference in its entirety.

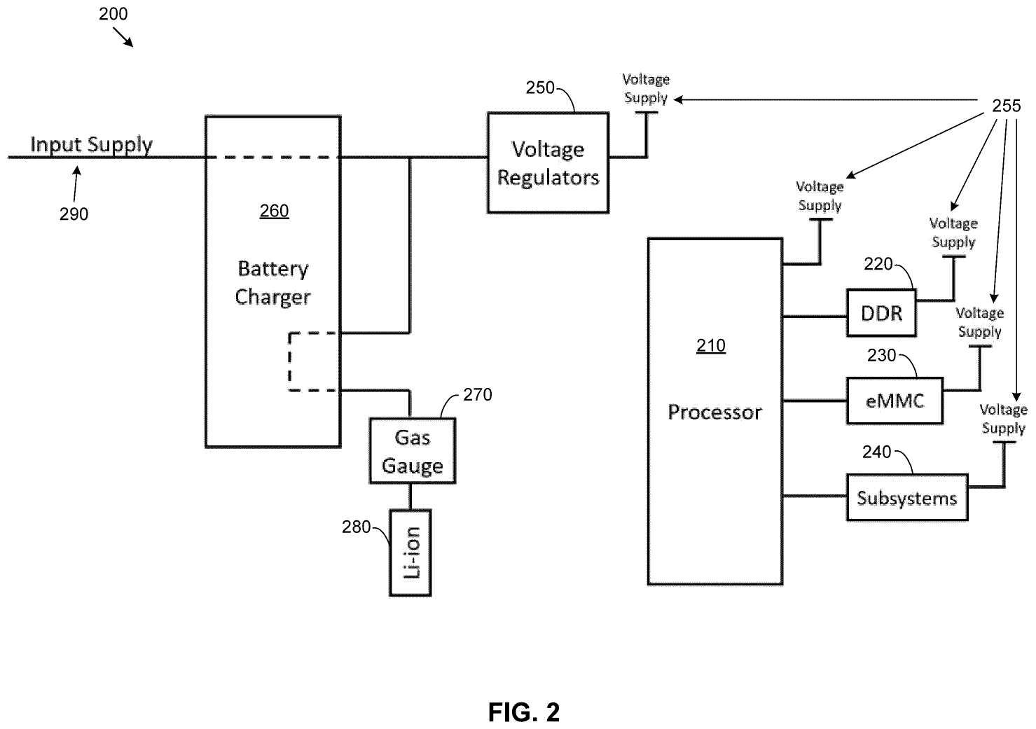

FIG. 2 is an example block diagram of components of a POS device 200 including a rechargeable battery 280. The POS device 200 may include a battery charger 260 which receives an input power 290 from an external source, such as a wall outlet. The battery charger 260 may charge the battery 280 using the input power 290. A gas gauge circuit 270 may monitor a charge of the battery 280 and control the battery charger 260 to charge the battery 280.

The POS device 200 may include voltage regulators 250 which receive the input power 290 and/or power from the battery 280. The battery 280 may provide power to the voltage regulators 250 in response to a loss of the input power 290. In an example, in the event of a power outage, causing the input power 290 to cease, the battery 280 may provide power to the voltage regulators 250. The voltage regulators 250 may regulate the input power 290 and/or the power from the battery 280 to provide a voltage supply 255.

The POS device may include a processor 210, a volatile memory 220, a non-volatile memory 230, and one or more subsystems 240. The voltage regulators 250 may provide the voltage supply 255 to the processor 210, the volatile memory 220, the non-volatile memory 230, and the one or more subsystems 240. The voltage supply 255 may be different for one or more of the processor 210, the volatile memory 220, the non-volatile memory 230, and the one or more subsystems 240. In an example, each of the processor 210, the volatile memory 220, the non-volatile memory 230, and the one or more subsystems 240 receive a different voltage supply 255 from the voltage regulators 250.

In some implementations, the processor 210 is an applications processor of the POS device 200, such as the applications processor 108 of FIG. 1. The processor 210 may be coupled to the volatile memory 220, the non-volatile memory 230, and the one or more subsystems 240. The processor 210 may control data writes to the volatile memory 220 and the non-volatile memory 230. The processor 210 may receive information from and/or control the one or more subsystems 240. The one or more subsystems 240 may include a display, an input device, a printer, a user interface, and other subsystems of the POS device 200. In an example, the POS device 200 includes a display and the processor 210 causes the display to present a user interface to a user. In an example, the POS device 200 includes a keypad and a display and the processor 210 causes the display to prompt user input at the keypad. In an example, the POS device 200 includes a touchscreen representing a display and input device of the POS device 200 controlled by the processor 210.

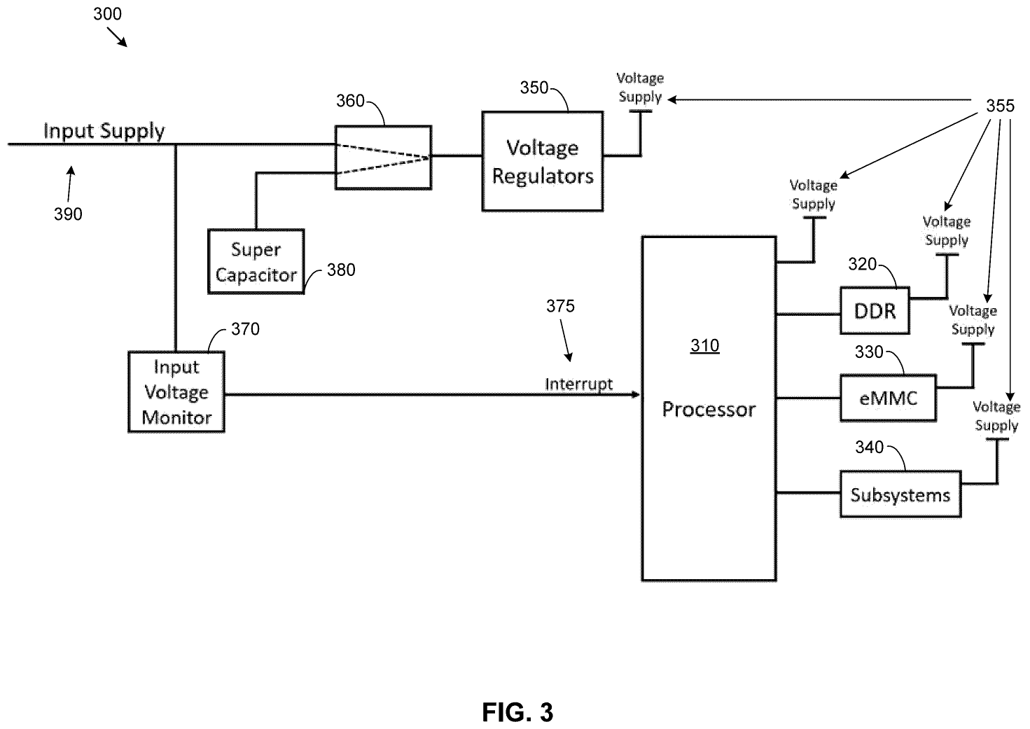

FIG. 3 is an example block diagram of components of a POS device 300 including a supercapacitor 380. The POS device 300 may receive an input power 390 from an external source, such as a wall outlet. The supercapacitor 380 may be charged using the input power 390. The supercapacitor 380 may also be referred to as an ultracapacitor. In some implementations, the supercapacitor 380 may store energy using electrostatic double-layer capacitance and/or electrochemical pseudocapacitance. In an example, the supercapacitor 380 includes two electrodes separated by an ion-permeable membrane and an electrolyte ionically connecting the two electrodes.

The POS device 300 may include voltage regulators 350 which receive the input power 390 and/or power from the supercapacitor 380. The supercapacitor 380 may provide power to the voltage regulators 350 in response to a loss of the input power 390. In an example, in the event of a power outage, causing the input power 390 to cease, the supercapacitor 380 may provide power to the voltage regulators 350. The voltage regulators 350 may regulate the input power 390 and/or the power from the supercapacitor 380 to provide a voltage supply 355.

The POS device may include a processor 310, a volatile memory 320, a non-volatile memory 330, and one or more subsystems 340. The voltage regulators 350 may provide the voltage supply 355 to the processor 310, the volatile memory 320, the non-volatile memory 330, and the one or more subsystems 340. The voltage supply 355 may be different for one or more of the processor 310, the volatile memory 320, the non-volatile memory 330, and the one or more subsystems 340. In an example, each of the processor 310, the volatile memory 320, the non-volatile memory 330, and the one or more subsystems 340 receive a different voltage supply 355 from the voltage regulators 350.

In some implementations, the processor 310 is an applications processor of the POS device 300, such as the applications processor 108 of FIG. 1. The processor 310 may be coupled to the volatile memory 320, the non-volatile memory 330, and the one or more subsystems 340. The processor 310 may control data writes to the volatile memory 320 and the non-volatile memory 330. The processor 310 may receive information from and/or control the one or more subsystems 340. The one or more subsystems 340 may include a display, an input device, a printer, a user interface, and other subsystems of the POS device 300. In an example, the POS device 300 includes a display and the processor 310 causes the display to present a user interface to a user. In an example, the POS device 300 includes a keypad and a display and the processor 310 causes the display to prompt user input at the keypad. In an example, the POS device 300 includes a touchscreen representing a display and input device of the POS device 300 controlled by the processor 310.

The volatile memory 320 may be a memory requiring power to store data. In an example, the volatile memory 320 is double data rate (DDR) synchronous dynamic random-access memory (SDRAM). In an example, the volatile memory 320 is random-access memory (RAM). The volatile memory 320 may be coupled to a memory controller for the volatile memory 320 configured to write data to and from the volatile memory 320. In some implementations, the memory controller for the volatile memory 320 is integrated into the processor 310. The non-volatile memory 330 may be a memory which retains data after power is lost, otherwise referred to as “storage memory.” In an example, the non-volatile memory 330 is an embedded multimedia card (eMMC). In an example, the non-volatile memory 330 is a hard drive, a secure digital (SD) drive, or a solid-state drive (SDD). The non-volatile memory 330 may be coupled to a memory controller for the non-volatile memory 330 configured to write data to and from the non-volatile memory 330. In some implementations, the memory controller for the non-volatile memory 330 is integrated into the processor 310.

The processor 310 may process the transaction data to approve or deny the transaction. In some implementations, the processor 310 may approve or deny transactions in an offline mode, where transaction approval cannot be obtained over payment networks. In the offline mode, the processor 310 may cache offline transaction data in the volatile memory 320 and/or store the offline transaction data in the non-volatile memory 330 for transaction approval once the POS device 300 is able to access the payment networks. In an example, the POS device 300 may be used to process transactions in a national park without a network connection and the POS device 300 stores the offline transaction data in the non-volatile memory 330 until the POS device 300 is taken to a city near the national park where a network connection can be established to provide the offline transaction data to the payment networks for approval. When transactions are being processed, and/or when transaction data is cached in the volatile memory 320, there is a risk that the transaction data may be lost if the input power 390 is suddenly lost. The transaction data of a transaction being processed when the input power 390 is lost may be corrupted if the processor 310 is in the process of writing the transaction data to the non-volatile memory 300. Transaction data that is cached in the volatile memory 320 may be lost when the input power 390 is lost.

To prevent loss or corruption of transaction data, the POS device 300 includes the supercapacitor 380 which provides power after a loss of the input power 390 to allow the transaction data to be written to the non-volatile memory 330. The supercapacitor 380 may be charged using the input power 390 in order to provide power after the input power 390 is lost. The supercapacitor may store a predetermined amount of power to allow the POS device 300 to perform a graceful shutdown (i.e., a shutdown without lost or corrupted data).

The POS device 300 may include an input voltage monitor 370 to monitor a voltage of the input power 390. The input voltage monitor 370 may identify a loss of the input power 390 based on the voltage of the input power 390 dropping below a predetermined threshold. The input voltage monitor 370 may send an alert to the processor 310 in response to the loss of the input power 390. The alert to the processor 310 may indicate the loss of the input power 390. In some implementations, the alert to the processor 310 indicates that the supercapacitor 380 is providing power. In some implementations, the alert to the processor 310 includes an amount of time the supercapacitor can provide power or an amount of power the supercapacitor can provide. In some implementations, the alert may include a hardware interrupt 375. The hardware interrupt 375 may interrupt one or more processes of the processor 310.

In response to the loss of the input power 390, the supercapacitor 380 may automatically provide power to the voltage regulators 350. In some implementations, the POS device includes a switch circuit 360 to switch from providing power from the input power 390 to providing power from the supercapacitor 380. In some implementations, the switch circuit 360 includes circuitry to automatically draw power from the supercapacitor 380 in response to the loss of the input power 390.

The processor 310, in response to the alert from the input voltage monitor 370 indicating the loss of the input power 390, may shut down the one or more subsystems 340 of the POS device 300. The processor 310 may shut down the one or more subsystems 340 of the POS device 300 to conserve the power supplied by the supercapacitor 380. The one or more subsystems 340 may include a display subsystem including a display. Shutting down the one or more subsystems 340 may include shutting down the display and/or a graphics processor for the display. Shutting down the one or more subsystems 340 may be performed by a kernel of an operating system running on the processor 310. By shutting down the one or more subsystems 340 using the kernel, or in kernel space, the processor 310 may shut down the one or more subsystems more quickly than shutting down the one or more subsystems 340 in user space. In this way, the processor 310 may conserve the power supplied by the supercapacitor 380, allowing for the supercapacitor 380 to be smaller while still allowing the processor 310 to execute a graceful shutdown.

In some implementations, shutting down the one or more subsystems may include sending, by the processor 310, a shutdown command to the one or more subsystems. In an example, the processor 310 makes one or more power off API calls to the one or more subsystems. In some implementations, shutting down the one or more subsystems may include turning off the power supply to the one or more subsystems. In an example, the processor 310 turns off the voltage regulators that supply power to the one or more subsystems. In some implementations, shutting down the one or more subsystems may include physically disconnecting the one or more subsystems from the power provided by the supercapacitor 380.

The supercapacitor 380 may supply power to the processor 310, the volatile memory 320, and the non-volatile memory 330 to allow the processor 310 to write transaction data from the volatile memory 320 to the non-volatile memory 330. In some implementations, the processor 310 completes an in-progress write to the non-volatile memory 330. In some implementations, the processor 310 transfers cached transaction data in the volatile memory 320 to the non-volatile memory 330. The supercapacitor 380 may store an amount of power to allow the processor 310 to complete all write operations from the volatile memory 320 to the non-volatile memory 330.

In response to the transaction data being stored in the non-volatile memory 330, or in response to the processor 310 completing all the write operations from the volatile memory 320 to the non-volatile memory 330, the processor 310 may shut down the POS device 300. In this way, the POS device 300 is not shut down until the transaction data is moved from the volatile memory 320 to the non-volatile memory 330, using power provided by the supercapacitor 380 and preventing corruption and/or loss of the transaction data. This shutdown may be termed a graceful shutdown, as the transaction data is not lost or corrupted during shutdown. In some implementations, the processor 310 may shut down the POS device 300 and complete the graceful shutdown within 500 ms of the notification of the loss of the input power 390. The supercapacitor 380 may provide power to the processor 310 for an amount of time sufficient to complete the graceful shutdown. The supercapacitor 380 may provide power to the processor 310, the volatile memory 320, and the non-volatile memory 330 for the amount of time sufficient to complete the graceful shutdown, or to write the transaction data to the non-volatile memory 330. In some implementations, the supercapacitor 380 provides power for about 220 ms to one second after the loss in power to the POS device 300, which is sufficient time to complete the graceful shutdown, or to write the transaction data to the non-volatile memory 330.

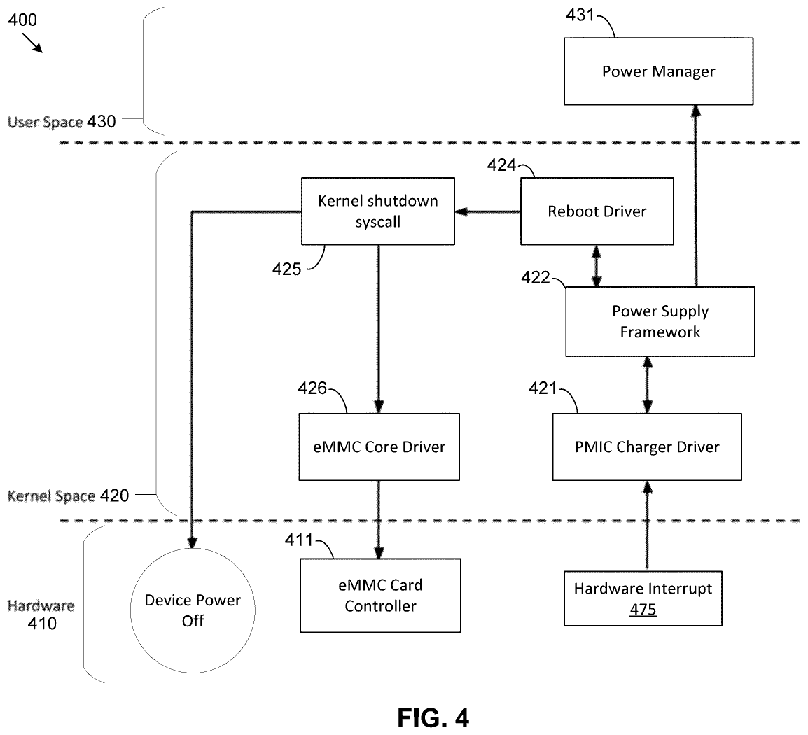

FIG. 4 is an example block diagram illustrating a system 400 for implementing a graceful shutdown for a POS device. The system 400 may include one or more hardware and/or software components. The system 400 may include a hardware level 410, a kernel space 420, and a user space 430. The hardware level 410 may include a hardware interrupt 475. The hardware interrupt may be received by a processor of a POS device from a voltage monitor, such as the hardware interrupt 375 of FIG. 3. A power management integrated circuit (PMIC) charger driver 421 may listen to the hardware interrupt 475. The PMIC charger driver 421, in response to the hardware interrupt 475, informs a power supply framework 422 of the change in power state (i.e., loss of input power). The power supply framework 422 notifies a reboot driver 424 of the change in power state. In some implementations, the power supply framework 422 informs a power manager 431 in the user space 430 of the change in power state. However, waiting for the power manager 431 to shut down subsystems of the POS device takes longer than shutting down the subsystems from the kernel space. The reboot driver 424 initiates a shutdown process directly from the kernel space by calling power off functions provided by a kernel shutdown syscall 425. The kernel shutdown syscall 425 may a kernel system call to shut down. The kernel shutdown syscall 425 may send one or more shutdown commands to power off subsystems of the POS device. The subsystems of the POS device may register for a power off notification. The one or more shutdown commands from the kernel shutdown syscall 425 may include the power off notification to shut down the subsystems which register for the power off notification.

The kernel shutdown syscall 425 notifies a non-volatile memory driver 426 of the shutdown process. In some implementations, the non-volatile memory driver 426 is an eMMC core driver. The non-volatile memory driver 426 sends a shutdown notification to a non-volatile memory controller 411. In some implementations, the non-volatile memory controller 411 is an eMMC card controller. The non-volatile memory controller 411 flushes data currently being transferred (in-flight data) and cached data to the non-volatile memory (e.g., eMMC). In an example, the non-volatile memory controller 411 sends a POWER_OFF_SHORT notification to the non-volatile memory for a faster shutdown. In this example, the non-volatile memory may complete the data and shutdown operations within 255 ms.

The kernel shutdown syscall 425 ends the graceful shutdown by powering off the POS device. The kernel shutdown syscall 425 may power off the POS device based on the non-volatile memory completing the data and shutdown operations. The kernel shutdown syscall 425 may power off the POS device based on an amount of time elapsing since the kernel shutdown syscall 425 notified the non-volatile memory driver 426 of the shutdown process.

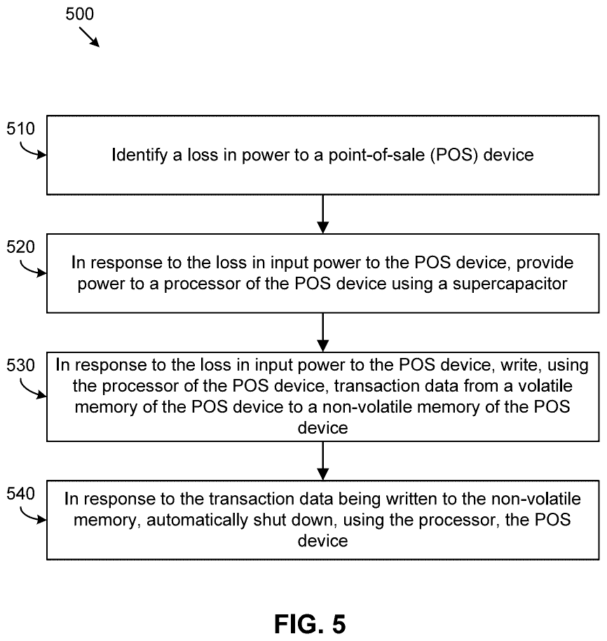

FIG. 5 is an example flow chart of a method 500 for implementing a graceful shutdown for a POS device. The method 500 may include more, fewer, or different operations than shown. The operations may be performed in the order shown, in a different order, or concurrently. The method 500 may be performed by the POS 300 of FIG. 3.

At operation 510, a loss in power to a POS device is identified. In some implementations, identifying the loss in power includes monitoring an input voltage to the POS device. In some implementations, identifying the loss in input power includes determining that the input voltage has dropped below a predetermined threshold.

At operation 520, in response to the loss in input power to the POS device, power is provided to a processor of the POS device using a supercapacitor.

In some implementations, the method 500 includes, in response to the loss in input power to the POS device, shutting down, by the processor, subsystems of the POS device to conserve the power provided by the supercapacitor. In some implementations, shutting down the subsystems of the POS device includes shutting down a display of the POS device. In some implementations, shutting down, by the processor, the subsystems of the POS device includes shutting down the subsystems of the POS device directly from a kernel of an operating system running on the processor. In some implementations, the method 500 includes making, by the processor of the POS device, a power off API call to the one or more subsystems of the POS device.

At operation 530, in response to the loss of input power to the POS device, transaction data is written, using the processor of the POS device, from a volatile memory of the POS device to a non-volatile memory of the POS device. In some implementations, the transaction data includes transaction data which was being written to the storage memory when the loss in power was identified. In some implementations, the transaction data includes cached transaction data in the volatile memory. In some implementations, the processor stores the transaction data in the non-volatile memory within 500 ms of the identification of the loss in power.

In some implementations, the processor shuts down the one or more subsystems before completing the write operations. In some implementations, the processor completes the write operations before shutting down the one or more subsystems. In some implementations, the processor begins the write operations before beginning to shut down the one or more subsystems. In some implementations, the processor begins to shut down the one or more subsystems before beginning the write operations.

At operation 540, in response to the transaction data being written to the non-volatile memory, the POS device is automatically shut down using the processor.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A point-of-sale (POS) device, comprising:
an input device configured to receive transaction data;
a processor configured to process the transaction data;
a memory controller configured to store the transaction data in a non-volatile memory;
a voltage monitor configured to monitor an input voltage to the POS device from an external power source to identify a loss in power to the POS device and provide an alert to the processor indicating the loss in power; and
a supercapacitor configured to provide power to the processor and memory controller in response to the alert,
wherein the supercapacitor provides power for an amount of time sufficient to store the transaction data in the non-volatile memory.

2. The POS device of claim 1, further comprising a volatile memory, wherein the processor causes the transaction data to be moved from the volatile memory to the non-volatile memory.

3. The POS device of claim 2, wherein the transaction data includes transaction data which was being written to the non-volatile memory when the loss in power was identified.

4. The POS device of claim 1, wherein the transaction data includes cached transaction data in the volatile memory.

5. The POS device of claim 1, wherein the processor, in response to the alert indicating the loss in power, shuts down subsystems of the POS device to conserve the power provided by the supercapacitor.

6. The POS device of claim 5, further comprising a display, wherein shutting down the subsystems of the POS device includes shutting down the display.

7. The POS device of claim 5, wherein shutting down the subsystems of the POS device includes shutting down the subsystems of the POS device directly from a kernel of an operating system running on the processor.

8. The POS device of claim 1, wherein the processor, in response to the transaction data being stored in the storage memory during the loss in power, shuts down the POS device.

9. The POS device of claim 1, wherein the voltage monitor identifies the loss in power by determining that the input voltage has dropped below a predetermined threshold.

10. The POS device of claim 1, wherein the transaction data is stored in the non-volatile memory within 500 ms of the voltage monitor identifying the loss in power.

11. A method, comprising:
identifying a loss in input power from an external power source to a point-of-sale (POS) device;
in response to the loss in input power to the POS device, providing power to a processor and memory controller of the POS device using a supercapacitor;
in response to the loss in input power to the POS device, writing, using the processor of the POS device, transaction data from a volatile memory of the POS device to a non-volatile memory of the POS device, wherein the supercapacitor provides power for an amount of time sufficient to write the transaction data to the non-volatile memory; and
in response to the transaction data being written to the non-volatile memory, automatically shutting down, using the processor, the POS device.

12. The method of claim 11, wherein identifying the loss in input power includes monitoring a voltage of the input power to the POS device.

13. The method of any of claim 12, wherein identifying the loss in input power includes determining that the voltage has dropped below a predetermined threshold.

14. The method of claim 11, wherein the transaction data includes transaction data which was being written to the non-volatile memory when the loss in power was identified.

15. The method of claim 11, wherein the transaction data includes cached transaction data in the volatile memory.

16. The method of claim 15, further comprising, in response to the loss in input power to the POS device, shutting down, by the processor, subsystems of the POS device to conserve the power provided by the supercapacitor.

17. The method of claim 16, wherein shutting down the subsystems of the POS device includes shutting down a display of the POS device.

18. The method of claim 16, wherein shutting down, by the processor, the subsystems of the POS device includes shutting down the subsystems of the POS device directly from a kernel of an operating system running on the processor.

19. The method of claim 18, further comprising making, by the processor, a power off API call to the subsystems of the POS device.

20. The method of claim 11, wherein the transaction data is written to the non-volatile memory within 500 ms of identifying the loss in power.
